(19) United States
(12) Patent Application Publication
(10) Pub. No.: US 2023/0143093 A1
(43) Pub. Date: May 11, 2023

(54) HEAT-CURABLE MALEIMIDE RESIN COMPOSITION

(71) Applicant: Shin-Etsu Chemical Co., Ltd., Tokyo (JP)

(72) Inventors: Atsushi TSUURA, Annaka-shi (JP); Yoshihiro TSUTSUMI, Annaka-shi (JP); Hiroyuki IGUCHI, Annaka-shi (JP); Yuki KUDO, Annaka-shi (JP)

(73) Assignee: Shin-Etsu Chemical Co., Ltd., Tokyo (JP)

(21) Appl. No.: 18/053,864

(22) Filed: Nov. 9, 2022

(30) Foreign Application Priority Data
Nov. 10, 2021 (JP) 2021-183052

(51) Int. Cl. C08L 53/02; C09J 153/02

(52) U.S. Cl. CPC C08L 53/025; C09J 153/025

(57) ABSTRACT

Provided is a heat-curable maleimide resin composition exhibiting no turbidity and separation when in the form of a varnish, and yielding a cured product that not only has excellent dielectric properties but also has a strong adhesive force to organic resins such as LCP and MPI and copper. The composition contains:
(A) a styrene-based elastomer having a reactive functional group at both ends;
(B) a maleimide compound represented by the following formula (1)

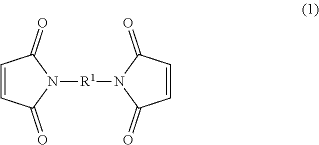

wherein R¹ represents a dimer acid skeleton-derived divalent hydrocarbon group;
(C) an epoxy resin having at least two epoxy groups per molecule; and
(D) an anionic polymerization initiating catalyst,
   wherein a ratio between the components (A) and (B) (mass ratio (A)/(B)) is 2 to 20.

### BACKGROUND OF THE INVENTION

### Field of the Invention

The present invention relates to a heat-curable maleimide resin composition; a cured or uncured resin film, an adhesive agent and an encapsulation material that are each comprised of such resin composition; and a substrate comprising a cured product of such heat-curable maleimide resin composition.

### Background Art

In recent years, the next-generation mobile communication system known as 5G has prevailed, where attempts are now being made to realize a high-speed, large-capacity and low-delay communication. In order to realize such communication, materials for use in high-frequency band are needed, and it is essential to reduce transmission loss as a countermeasure for noises, whereby an insulating material with excellent dielectric properties (low relative permittivity and low dielectric tangent) is required to be developed.

Particularly, desired is an insulating material that has excellent dielectric properties and is for use in substrates. Insulating materials superior in dielectric properties are demanded for substrates such as a rigid substrate, a flexible substrate or the like. Here, in the case of a rigid substrate, reactive polyphenylene ether resins (PPE) are becoming used; and in the case of a flexible printed-circuit board (FPC), liquid crystal polymers (LCP) and products called modified polyimides (MPI) with improved properties are becoming used.

When producing the above FPC, there will be required an adhesive agent for attaching, via hot pressing or the like, a base film or a coverlay film to for example a surface having wiring parts. While adhesive agents mainly comprised of epoxy resins have been used conventionally, even materials used in adhesive agents nowadays are becoming required to possess excellent dielectric properties.

Given such background, reports have been made on adhesive agents with excellent dielectric properties (e.g. JP-A-2008-248141, JP-A-2011-68713, WO2016/17473 and JP-A-2016-79354); most of them are combinations of epoxy resins and other heat-curable and thermoplastic resins. While these compositions have superior dielectric properties in a frequency region of not higher than 10 GHz, 5G requires that dielectric properties be exhibited even in a frequency region of not lower than 28 GHz which constitutes millimeter waves; many of the conventional adhesive agents that are said to possess excellent dielectric properties are considered as not having satisfactory dielectric properties by modern standards.

Further, a resin composition containing a particular maleimide compound and a thermoplastic resin has superior high-frequency properties, and is disclosed as a composition also having a high level of adhesiveness to a conductor (WO2018/16489).

### SUMMARY OF THE INVENTION

However, as for the resin composition described in WO2018/16489, it was confirmed that the resins had no compatibility to each other when in the form of a varnish whereby separation had occurred therein, which made it impossible to obtain a resin film; and that no adhesiveness was expressed even when a resin film was able to be obtained. That is, it became clear that this resin composition was not fit for use in substates.

Thus, it is an object of the present invention to provide a heat-curable maleimide resin composition exhibiting no turbidity and separation when in the form of a varnish, and yielding a cured product that not only has excellent dielectric properties but also has a strong adhesive force to organic resins such as LCP and MPI and copper; a cured or uncured resin film, an adhesive agent and an encapsulation material that are each comprised of such resin composition; and a substrate comprising a cured product of such heat-curable maleimide resin composition.

The inventors of the present invention diligently conducted a series of studies to solve the above problems, and completed the invention by finding out that the heat-curable maleimide resin composition shown below was capable of achieving the above object.

[1]

A heat-curable maleimide resin composition comprising:

(A) a styrene-based elastomer having a reactive functional group at both ends;

(B) a maleimide compound represented by the following formula (1)

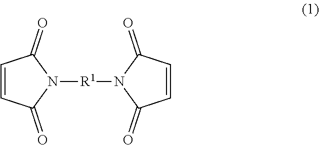

wherein R¹ represents a dimer acid skeleton-derived divalent hydrocarbon group;

(C) an epoxy resin having at least two epoxy groups per molecule; and

(D) an anionic polymerization initiating catalyst,

wherein a ratio between the components (A) and (B) (mass ratio (A)/(B)) is 2 to 20.
[2]

The heat-curable maleimide resin composition according to [1], wherein the styrene-based elastomer as the component (A) is a copolymer of styrene and a carbon-carbon double bond-containing compound, and the reactive functional group at the both ends thereof includes at least one of an amino group, a carboxyl group and a vinyl group.

[3]

The heat-curable maleimide resin composition according to [1] or [2], wherein the component (D) is at least one compound selected from an imidazole compound, a phosphorus compound and an amine compound.

[4]

An uncured resin film comprising the heat-curable maleimide resin composition according to any one of [1] to [3].

[5]

A cured resin film comprising a cured product of the heat-curable maleimide resin composition according to any one of [1] to [3].

[6]

An adhesive agent comprising the heat-curable maleimide resin composition according to any one of [1] to [3].

[7]

An encapsulation material comprising the heat-curable maleimide resin composition according to any one of [1] to [3].

[8]

A substrate comprising the cured product of the heat-curable maleimide resin composition according to any one of [1] to [3].

The heat-curable maleimide resin composition of the present invention exhibits no separation and turbidity even when in the form of a varnish, and the cured product thereof is superior in dielectric properties and adhesive force; particularly, the cured product has a strong adhesive force to organic resins such as LCP and MPI and copper. Thus, the heat-curable maleimide resin composition of the present invention is particularly useful as a material for use in FPC.

### DETAILED DESCRIPTION OF THE INVENTION

The present invention is described in greater detail hereunder.

### (A) Styrene-Based Elastomer Having Reactive Functional Group at Both Ends

A styrene-based elastomer as a component (A) mainly contributes to improvements in dielectric properties, heat resistance and adhesiveness of a cured product of the composition at high frequencies, as well as improvement in flexibility of the composition after it was turned into a film. There are no particular restrictions on this elastomer so long as it is a thermoplastic elastomer having a styrene-based compound-derived structural unit, and having a reactive functional group at both ends; the elastomer may be a thermoplastic elastomer having a styrene-derived structural unit.

In the present invention, a styrene-based elastomer is a copolymer of styrene and a carbon-carbon double bond-containing compound, and is preferably a partially or completely hydrogenated copolymer. That is, the styrene-based elastomer is preferably a block and/or random copolymer with styrene being a hard segment, and the carbon-carbon double bond-containing compound being a soft segment; examples of such styrene-based elastomer include a styrene-butadiene-styrene block or random copolymer, a styrene-isoprene-styrene block or random copolymer, a styrene-ethylene-butylene-styrene block or random copolymer, a styrene-ethylene-propylene-styrene block or random copolymer, and a styrene-butadiene block or random copolymer. In terms of quality stability, a block copolymer is preferred.

In terms of heat resistance, it is preferred that there be used, for example, a styrene-ethylene-butylene-styrene block or random copolymer, a styrene-ethylene-propylene-styrene block or random copolymer and a styrene-butadiene block or random copolymer that have lost the double bonds of the carbon-carbon double bond-containing compound due to a hydrogenation reaction (hydrogenation). Hydrogenation may be either partial hydrogenation or complete hydrogenation; in terms of heat resistance, more preferred is complete hydrogenation or that yielding a high hydrogenation rate.

In the styrene copolymer, a mass ratio of styrene/carbon-carbon double bond-containing compound and moieties thereof with double bonds hydrogenated, is preferably 10/90 to 70/30, more preferably 20/80 to 67/33. When the mass ratio is within these ranges, there can be achieved a composition with an excellent compatibility and dispersibility as well as a stable quality. That is, on a mass basis, it is preferred that styrene be contained in the styrene-based elastomer by a ratio of 10 to 70%, more preferably 20 to 67%.

Further, both ends of the styrene-based elastomer as the component (A) are each modified by at least one kind of reactive functional group selected from an amino group, a carboxyl group and a vinyl group. In this way, the component (A) shall react with a later-described component (B) whereby a cured product superior in heat resistance can be obtained. Modification of the styrene-based elastomer can be performed by, for example, copolymerizing an unsaturated carboxylic acid at the time of polymerizing the styrene-based elastomer. Further, such modification may also be performed by heating and kneading the styrene-based elastomer and an unsaturated carboxylic acid under the presence of an organic peroxide. Examples of such unsaturated carboxylic acid include an acrylic acid, methacrylic acid, maleic acid, itaconic acid, fumaric acid, maleic acid anhydride, itaconic acid anhydride and fumaric acid anhydride. There are no particular restrictions on a method for amine-modifying the styrene-based elastomer; a known method may be used. For example, the amine modification may be performed by copolymerizing an amino group-containing unsaturated monomer and the styrene-based elastomer. Further, amine modification may also be carried out by performing polymerization using an amino group-containing polymerization initiator.

The number average molecular weight (Mn) of the component (A) is preferably 10,000 to 300,000, more preferably 10,000 to 200,000. When the number average molecular weight is within these ranges, the composition obtained will have a superior film-forming capability, the component (A) will have a superior compatibility and dispersibility to other components such as components (B) and (C), and a favorable adhesiveness will be exhibited as well.

Here, the number average molecular weight mentioned in this specification refers to a number average molecular weight measured by gel permeation chromatography (GPC) under the following conditions, using polystyrene as a reference substance.

### [Measurement Conditions]

Developing solvent: Tetrahydrofuran (THF)
Flow rate: 0.35 mL/min
Detector: Differential refractive index detector (RI)

### Column: TSK Guardcolumn Super H-L

TSK gel Super HZ4000 (4.6 mm I.D.×15 cm×1)

TSK gel Super HZ3000 (4.6 mm I.D.×15 cm×1)

TSK gel Super HZ2000 (4.6 mm I.D.×15 cm×2)

(All manufactured by Tosoh Corporation)
Column temperature: 40° C.
Sample injection volume: 5 μL (THF solution with a concentration of 0.2% by mass)

As the styrene-based elastomer of the component (A), there may be used one that is commercially available. Specific examples thereof include the Tuftec series by Asahi Kasei Corporation and the FG series by Kraton Corporation. Here, in the composition of the present invention, there may be used only one kind of styrene-based elastomer, or two or more kinds of styrene-based elastomers in a mixed manner. In the heat-curable maleimide resin composition of the present invention, the component (A) is preferably contained in an amount of 60 to 99% by mass, more preferably 65 to 95% by mass, even more preferably 70 to 93% by mass.

### (B) Maleimide Compound

A component (B) used in the present invention is a maleimide compound represented by the following formula (1), preferably a maleimide compound that is a reaction product of a dimer diamine and a maleic acid anhydride. Since the component (B) is a heat-curable resin and reacts with the component (A), there can be achieved a highly reliable composition with a favorable heat resistance and favorable mechanical properties. Moreover, since the component (B) has a dimer acid skeleton-derived divalent hydrocarbon group, it has favorable dielectric properties. Thus, the composition shall exhibit excellent dielectric properties as well.

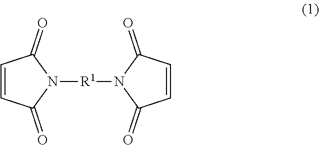

In the formula (1), R¹ represents a dimer acid skeleton-derived divalent hydrocarbon group.

A dimer acid refers to a liquid fatty acid whose main component is a dicarboxylic acid having 36 carbon atoms, which is produced by dimerizing an unsaturated fatty acid having 18 carbon atoms and employing a natural substance such as a vegetable fat or oil as its raw material; a dimer acid may have multiple structures as opposed to one single type of skeleton, and there exist several types of isomers. Typical dimer acids are categorized under the names of (a) linear type, (b) monocyclic type, (c) aromatic ring type, and (d) polycyclic type.

In this specification, a dimer acid skeleton refers to a group induced from a dimer diamine having a structure established by substituting the carboxy groups in such dimer acid with primary aminomethyl groups. Examples of the dimer acid skeleton-derived divalent hydrocarbon group include, but are not limited to those having the following structures.

Further, as for the dimer acid skeleton-derived divalent hydrocarbon group in the component (B), more preferred from the perspectives of heat resistance and reliability of the cured product are those having a structure with a reduced number of carbon-carbon double bonds in the dimer acid skeleton-derived hydrocarbon group due to a hydrogenation reaction.

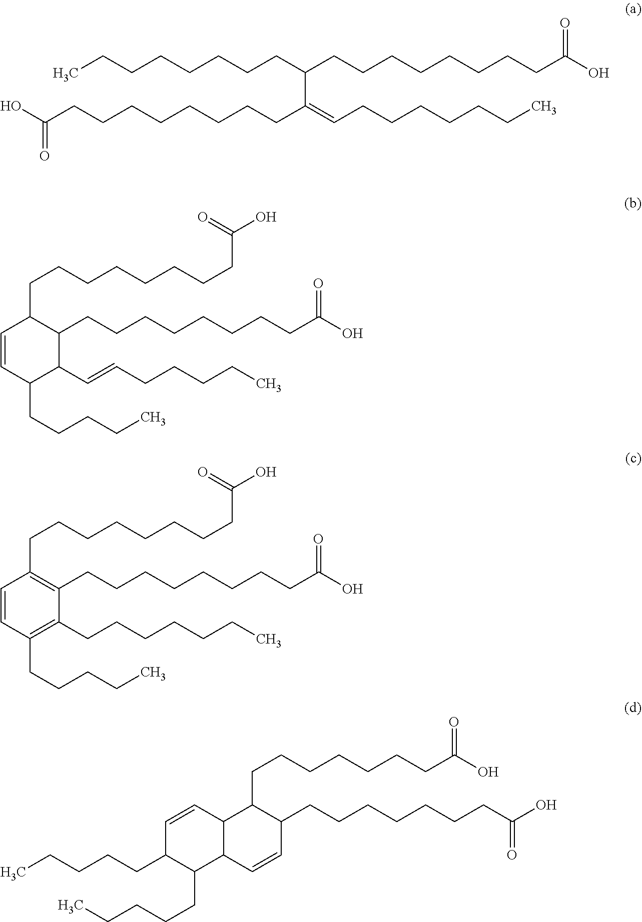 [SMILES: CCCCCCC/C=C(/CCCCCCCCC(=O)O)C(CCCCCCCC)CCCCCCCCC(=O)O ; CCCCC/C=C/C1C(CCCCC)C=CC(CCCCCCCCC(=O)O)C1CCCCCCCCC(=O)O ; CCCCCCCc1c(CCCCC)ccc(CCCCCCCCC(=O)O)c1CCCCCCCCC(=O)O ; CCCCCC1C=CC2C(C=CC(CCCCCCCC(=O)O)C2CCCCCCCC(=O)O)C1CCCCC]

If using, as the component (B), a maleimide compound other than that having the structure of the formula (1), a compatibility to the component (A) will be impaired whereby turbidity and separation will occur if the composition is to be prepared in the form of a varnish. In such case, an unevenness will occur in the composition such that the properties of the composition may vary.

A mass ratio between the components (A) and (B) ((A)/(B)) is 2 to 20, preferably 3 to 15. When this ratio is larger than 20, there will be more liquid components so that the film-forming capability may be impaired. In contrast, when this ratio is smaller than 2, there will be fewer heat-curable components so that the heat resistance may be impaired.

### (C) Epoxy Resin Having at Least Two Epoxy Groups Per Molecule

A component (C) used in the present invention is an epoxy resin having at least two epoxy groups per molecule. An epoxy resin is to improve the fluidity and mechanical properties of the heat-curable maleimide resin composition of the present invention, or improve an adhesive force to an organic resin such as LCP and MPI. There are no particular restrictions on such epoxy resin employed so long as it has two or more epoxy groups per molecule; in terms of compatibility to the components (A) and (B), preferred is one being liquid at room temperature (25° C.).

Specific examples of the epoxy resin include a bisphenol A-type epoxy resin; a bisphenol F-type epoxy resin; a biphenol-type epoxy resin such as 3,3%5,5′-tetramethyl-4,4′-biphenol type epoxy resin and 4,4′-biphenol type epoxy resin; a phenol novolac-type epoxy resin; a cresol novolac-type epoxy resin; a bisphenol A novolac-type epoxy resin; a naphthalenediol-type epoxy resin; a trisphenylol methane-type epoxy resin; a tetrakisphenylol ethane-type epoxy resin; a phenol biphenyl-type epoxy resin; a dicyclopentadiene-type epoxy resin; a biphenyl aralkyl-type epoxy resin; an epoxy resin obtained by hydrogenating the aromatic rings in a phenol dicyclopentadiene novolac-type epoxy resin; a triazine derivative epoxy resin; and an alicyclic epoxy resin. Particularly, a bisphenol A-type epoxy resin is preferably used.

It is preferred that the component (C) be added in an amount of 0.05 to 10 parts by mass, more preferably 0.1 to 7.0 parts by mass, per 100 parts by mass of a total amount of the components (A) and (B). If the amount of the component (C) added is larger than this range, the dielectric properties of the composition may deteriorate. Conversely, if the amount of the component (C) added is smaller than this range, the composition obtained may exhibit a poor adhesive force. Further, the curability of the composition may be impaired.

### (D) Anionic Polymerization Initiating Catalyst

An anionic polymerization initiating catalyst as a component (D) is added to mainly initiate and promote an anionic polymerization reaction between the components (A), (B) and (C).

There are no particular restrictions on the component (D) so long as it is capable of promoting the anionic polymerization reaction; preferred are at least one compound selected from an imidazole compound, a phosphorus compound and an amine compound.

Specific examples of the imidazole compound include imidazole, 2-methylimidazole, 2-ethylimidazole, 2-heptadecylimidazole, 1,2-dimethylimidazole, 2-ethyl-4-methylimidazole, 2-undecylimidazole, 2-phenylimidazole, 2-phenyl-4-methylimidazole, 1-benzyl-2-methylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 2-phenyl-4,5-dihydroxymethylimidazole, 2-phenyl-4-methyl-5-hydroxymethylimidazole, and a diaminotriazine ring-containing imidazole such as 2,4-diamino-6-[2′-methylimidazolyl-(1′)]-ethyl-s-triazine.

Specific examples of the phosphorus compound include tributylphosphine, tri(p-methylphenyl)phosphine, tri(nonylphenyl)phosphine, triphenylphosphine, triphenylphosphine-triphenylborane, and tetraphenylphosphine-tetraphenylborate.

Specific examples of the amine compound include triethylamine, benzyldimethylamine, α-methylbenzyldimethylamine, 1,8-diazabicyclo[5.4.0]undecene, and tris(dimethylaminomethyl)phenol.

Particularly preferred are anionic polymerization initiating catalysts such as the kinds of imidazole compounds and tertiary amine compounds that are capable of opening the rings of the epoxy groups in the component (C) whereby an adduct with the epoxy resin is then allowed to promote a cross-linking reaction of the maleimide compound.

It is preferred that the component (D) be added in an amount of 0.01 to 5.0 parts by mass, more preferably 0.05 to 3.0 parts by mass, per 100 parts by mass of the total amount of the components (A) and (B). If the amount of the component (D) added is larger than this range, the dielectric properties of the composition may deteriorate. Conversely, it is not preferable if the amount of the component (D) added is smaller than this range, because the curing speed of the composition may be slower.

### Other Additives

On the premise that the effects of the present invention will not be impaired, the heat-curable maleimide resin composition of the present invention may further contain various additives if necessary. Examples of such additives include inorganic fillers as typified by silica, alumina and boron nitride; resin powders as typified by a PTFE powder; metal particles such as silver particles; a reactive functional group-containing organopolysiloxane; a non-functional silicone oil; a thermoplastic resin; a thermoplastic elastomer other than those that are styrene-based; an organic synthetic rubber; a photosensitizer; a light stabilizer; a polymerization inhibitor; a flame retardant; a pigment; and a dye. Further, in order to improve the electric properties of the cured product of the heat-curable maleimide resin composition, an ion-trapping agent or the like may also be added as one other additive.

The heat-curable maleimide resin composition of the present invention can be produced by mixing the components (A), (B), (C) and (D) as well as other additives if needed. The heat-curable maleimide resin composition of the present invention may also be handled as a varnish when dissolved in an organic solvent. It is easier for the heat-curable maleimide resin composition to be molded into the shape of a sheet or a film if it is previously prepared in the form of a varnish. There are no restrictions on the organic solvent employed so long as it is capable of dissolving the components (A) and (B). As such organic solvent, there may be preferably used, for example, toluene, xylene, anisole, cyclohexanone and cyclopentanone. Any one of these organic solvents may be used alone, or two or more of them may be used in a mixed fashion. The concentration of the heat-curable maleimide resin composition of the present invention in the varnish is preferably 5 to 80% by mass, more preferably 10 to 75% by mass.

This heat-curable maleimide resin composition can be favorably and mainly used as an adhesive agent, a primer, a bonding film or sheet material for a substrate, an encapsulation material, an adhesion layer of a coverlay film for FPC, and a flexible flat cable. No restrictions are imposed on a method or embodiment by which the composition is used. For example, it may be used as an uncured resin film or a cured resin film, or as an adhesive agent. Examples of use include, but are not limited to those shown below.

For example, after applying to a support sheet the heat-curable maleimide resin composition dissolved in the organic solvent (i.e. varnish), heating is then performed at a temperature of normally not lower than 80° C., preferably not lower than 100° C. for 0.5 to 5 hours so as to eliminate the organic solvent, thereby obtaining an uncured film- or sheet-shaped composition. As the support sheet, there may be used those that are generally used, examples of which include sheets of polyolefin resins such as a polyethylene (PE) resin, a polypropylene (PP) resin and a polystyrene (PS) resin; and sheets of polyester resins such as a polyethylene terephthalate (PET) resin, a polybutylene terephthalate (PBT) resin and a polycarbonate (PC) resin. These support sheets may have their surfaces already subjected to a mold release treatment. Further, there are no particular restrictions on the application method; there may be used, for example, a gap coater, a curtain coater, a roll coater or a laminator. There are also no particular restrictions on the thickness of the applied layer; a thickness after distilling away the solvent is in a range of 1 to 100 preferably 3 to 80 Further, a cover film may be used on the applied layer.

Further, a copper foil may be attached onto the applied layer so that the sheet thus configured can also be used as a substrate material.

Also, the varnish may be applied to a base material, followed by performing heating at a temperature of normally not lower than 80° C., preferably not lower than 100° C. for 0.5 to 5 hours so as to eliminate the organic solvent, and then pressure-bonding what one wants bonded to the base material while performing heating at a temperature of not lower than 130° C., preferably not lower than 150° C. for 0.5 to 10 hours. The application method may be that using, for example, a spin coater, a slit coater, a sprayer, a dip coater or a bar coater; no particular restrictions are imposed on the application method.

### WORKING EXAMPLES

The present invention is described in detail hereunder with reference to working and comparative examples; the present invention shall not be limited to the following working examples.

(A) Styrene-based elastomer having reactive functional group at both ends
(A-1) Hydrogenated product of amine-modified styrene-ethylene-butylene-styrene block copolymer, styrene content 30%, number average molecular weight 33,000 (Tuftec MP10 by Asahi Kasei Corporation)
(A-2) Carboxylic acid-modified styrene-ethylene-butylene-styrene block copolymer, styrene content 30%, number average molecular weight 90,000 (Tuftec MP1913 by Asahi Kasei Corporation)
(A-3) Styrene-ethylene-butylene-styrene block copolymer, styrene content 30%, number average molecular weight 74,000 (Tuftec H1041 by Asahi Kasei Corporation, for use in comparative example)
(B) Maleimide compound
(B-1): Bismaleimide compound represented by the following formula (SLK-6895 by Shin-Etsu Chemical Co., Ltd.)

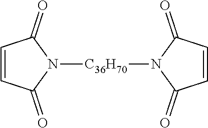

—C₃₆H₇₀— represents a dimer acid skeleton-derived hydrocarbon group.
(B-2): Bismaleimide compound represented by the following formula (SLK-3000 by Shin-Etsu Chemical Co., Ltd., for use in comparative example)

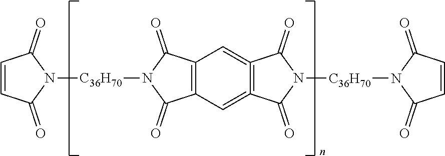

n≈5 (Average value)

—C₃₆H₇₀— represents a dimer acid skeleton-derived hydrocarbon group.
(B-3): 4,4′-diphenylmethanebismaleimide (BMI-1000 by Daiwakasei Industry Co., LTD., for use in comparative example)
(C) Epoxy resin
(C-1): Bisphenol A-type epoxy resin (jER-828 by Mitsubishi Chemical Corporation)
(C-2): Biphenyl aralkyl-type epoxy resin (NC-3000 by Nippon Kayaku Co., Ltd.)
(D) Anionic polymerization initiating catalyst
(D-1): 2-ethyl-4-methylimidazole (2E4MZ by SHIKOKU CHEMICALS CORPORATION)
(D-2): 2,4-diamino-6-[2′-methylimidazolyl-(1′)]-ethyl-s-triazine (2MZ-A by SHIKOKU CHEMICALS CORPORATION)

### Production of Varnish

At the compounding ratios shown in Tables 1 and 2, the components were put into a 500 mL four-necked flask equipped with a Dimroth condenser and a stirrer, and then stirred at 50° C. for two hours to obtain a varnish-like resin composition.

### Appearance of Varnish

The varnish before being turned into a film had no undissolved residues or turbidity when observed visually, and a 30% by mass xylene solution of this resin composition was put into a quartz cell so as to measure a straight light transmissibility at an optical path length of 1 mm, a wavelength of 740 nm and a temperature of 25° C., using a spectrophotometer U-4100 (by Hitachi High-Tech Science Corporation). Here, examples exhibiting light transmissibilities of not lower than 70% were marked ⊚; examples exhibiting light transmissibilities of not lower than 50%, but lower than 70% were marked ∘; and examples exhibiting light transmissibilities of lower than 50% were marked x.

### Production of Uncured Film

A roller coater was used to apply the varnish-like heat-curable maleimide resin composition to a PET film of a thickness of 38 μm so that the thickness of the composition after drying would be 50 followed by performing drying at 120° C. for 10 min to obtain an uncured resin film.

### Handling Property of Uncured Resin Film

After bending the uncured resin film at a 90-degree angle at 25° C., there was visually confirmed whether cracks and/or breakages had occurred in the film. Here, examples exhibiting no cracks, breakages, tacks and the like at all were marked ∘; whereas examples exhibiting even a slight level of cracks, breakages, tacks or the like were marked x.

TABLE 1

| Composition compounding table | | | Working example | | | | | | |
|---|---|---|---|---|---|---|---|---|---|
| (part by mass) | | | 1 | 2 | 3 | 4 | 5 | 6 | 7 |
| (A) | Tuftec MP10 | A-1 | 95 | 90 | 80 | 70 | | 90 | 90 |
| | Tuftec M1913 | A-2 | | | | | 90 | | |
| | Tuftec H1041 | A-3 | | | | | | | |
| (B) | SLK-6895 | B-1 | 5 | 10 | 20 | 30 | 10 | 10 | 10 |
| | SLK-3000 | B-2 | | | | | | | |
| | BMI-1000 | B-3 | | | | | | | |
| (C) | jER-828 | C-1 | 3 | 3 | 3 | 3 | 3 | | 3 |
| | NC-3000 | C-2 | | | | | | 3 | |
| (D) | 2E4MZ | D-1 | 0.1 | 0.1 | 0.1 | 0.1 | 0.1 | 0.1 | |
| | 2MZ-A | D-2 | | | | | | | 0.1 |
| Solvent | Xylene | | 250 | 250 | 250 | 250 | 250 | 250 | 250 |
| Ratio | (A)/(B) | | 19.0 | 9.0 | 4.0 | 2.3 | 9.0 | 9.0 | 9.0 |
| Evaluation | Varnish appearance | | ⊚ | ⊚ | ⊚ | ⊚ | ⊚ | ⊚ | ⊚ |
| results | Handling property | | ◯ | ◯ | ◯ | ◯ | ◯ | ◯ | ◯ |
| | of uncured resin | | | | | | | | |
| | film | | | | | | | | |

TABLE 2

| Composition compounding table | | | Comparative example | | | | |
|---|---|---|---|---|---|---|---|
| (part by mass) | | | 1 | 2 | 3 | 4 | 5 |
| (A) | Tuftec MP10 | A-1 | 90 | 90 | | 60 | 96 |
| | Tuftec M1913 | A-2 | | | | | |
| | Tuftec H1041 | A-3 | | | 90 | | |
| (B) | SLK-6895 | B-1 | | | 10 | 40 | 4 |
| | SLK-3000 | B-2 | 10 | | | | |
| | BMI-1000 | B-3 | | 10 | | | |
| (C) | jER-828 | C-1 | 3 | 3 | 3 | 3 | 3 |
| | NC-3000 | C-2 | | | | | |
| (D) | 2E4MZ | D-1 | 0.1 | 0.1 | 0.1 | 0.1 | 0.1 |
| | 2MZ-A | D-2 | | | | | |
| Solvent | Xylene | | 250 | 250 | 250 | 250 | 250 |
| Ratio | (A)/(B) | | 9.0 | 9.0 | 9.0 | 1.5 | 24.0 |
| Evaluation | Varnish appearance | | ◯ | X | ⊚ | ⊚ | ⊚ |
| results | Handling property | | ◯ | X | ◯ | X | ◯ |
| | of uncured | | | | | | |
| | resin film | | | | | | |

The results shown in Tables 1 and 2 indicate that the varnish compositions of the working examples 1 to 7 were each in a stable condition as exhibiting no separation and turbidity. The varnish compositions of the comparative examples 3 to 5 were also each confirmed to be in a stable condition. In contrast, turbidity was observed in the varnishes of the comparative examples 1 and 2.

The results shown in Tables 1 and 2 indicate that in terms of uncured resin film property, the uncured resin films of the working examples 1 to 7 exhibited no cracks, breakages or the like. Cracks or the like were also not observed in the comparative examples 1, 3 and 5 as are the cases with the working examples. In contrast, cracks and/or tacks were observed in the comparative examples 2 and 4. As for the comparative examples 2 and 4, evaluations thereafter were stopped.

### Relative Permittivity, Dielectric Tangent

The uncured resin film was treated at 180° C. for two hours to obtain a cured resin film, followed by cutting such cured resin film into test pieces each having a size of 60 mm×60 mm. An SPDR dielectric resonator (MS46122B by ANRITSU CORPORATION) was then used to measure the relative permittivities and dielectric tangents of these test pieces at 10 GHz and 25° C.

### Heat Resistance

As for the cured resin film produced by the above process, the aforementioned device was used to measure the dielectric properties thereof at 10 GHz and 25° C. after the cured resin film had been stored at 150° C. for 500 hours. Here, ∘ was given to examples where a rate of change in a dielectric tangent value at 10 GHz before and after the storage was lower than 100%; and x was given to examples where such rate was 100% or higher.

### Peeling Strength

There was prepared a glass slide having a length of 75 mm, a width of 25 mm and a thickness of 1.0 mm, and the PET film-attached uncured resin film was then placed on one of the surfaces of the glass slide in a way such that the resin composition surface with no PET base material attached thereto would come into contact with the abovementioned one surface of the glass slide; lamination was then performed at 120° C. and 0.3 MPa for 60 sec. After the lamination was over, the PET base material was peeled away, followed by placing an 18 μm thick copper foil (by MITSUI MINING & SMELTING CO., LTD., Ra 0.6 μm), a 50 μm thick LCP (by CHIYODA INTEGRE CO., LTD.) or a 50 μm MPI (PIXEO SR by KANEKA CORPORATION) on the resin composition surface, and then performing lamination at 120° C. and 0.3 MPa for 60 sec. After the lamination was over, curing was performed at 180° C. for two hours to obtain an adhesion test piece.

Adhesiveness was evaluated in a way such that there was measured a 90° peeling adhesion strength (kN/m) at the time of peeling the copper foil, LCP or MPI of each adhesion test piece from the glass slide at a temperature of 23° C. and a tensile rate of 50 mm/min, in accordance with “Test methods of copper-clad laminates for printed wiring boards” of JIS-C-6481.

The above evaluation results are shown in Tables 3 and 4.

TABLE 3

| | | Working example | | | | | | |
|---|---|---|---|---|---|---|---|---|
| | Unit | 1 | 2 | 3 | 4 | 5 | 6 | 7 |
| Heat resistance | | ◯ | ◯ | ◯ | ◯ | ◯ | ◯ | ◯ |
| Relative permittivity(10 GHz) | | 2.31 | 2.30 | 2.32 | 2.34 | 2.30 | 2.31 | 2.29 |
| Dielectric tangent(10 GHz) | | 0.0012 | 0.0014 | 0.0016 | 0.0018 | 0.0014 | 0.0013 | 0.0014 |
| Relative permittivity(28 GHz) | | 2.32 | 2.30 | 2.33 | 2.36 | 2.31 | 2.32 | 2.31 |
| Dielectric tangent(28 GHz) | | 0.0012 | 0.0015 | 0.0018 | 0.0020 | 0.0015 | 0.0014 | 0.0016 |
| Copper foil peeling strength | kN/m | 1.9 | 2.0 | 1.8 | 1.3 | 1.7 | 1.8 | 1.9 |
| MPI peeling strength | kN/m | 1.2 | 1.1 | 0.8 | 0.7 | 1.0 | 1.1 | 1.1 |
| LCP peeling strength | kN/m | 1.3 | 1.1 | 1.0 | 0.8 | 1.1 | 1.0 | 1.1 |

TABLE 4

| | | Comparative example | | |
|---|---|---|---|---|
| | Unit | 1 | 3 | 5 |
| Heat resistance | | ∘ | x | x |
| Relative permittivity(10 GHz) | | 2.35 | 2.28 | 2.29 |
| Dielectric tangent(10 GHz) | | 0.0014 | 0.0011 | 0.0010 |
| Relative permittivity(28 GHz) | | 2.36 | 2.30 | 2.31 |
| Dielectric tangent(28 GHz) | | 0.0015 | 0.0012 | 0.0012 |
| Copper foil peeling strength | kN/m | 2.0 | 1.6 | 2.2 |
| MPI peeling strength | kN/m | 1.1 | 0.8 | 1.0 |
| LCP peeling strength | kN/m | 1.2 | 0.8 | 1.1 |

As can be seen from the above results, in the case of the heat-curable maleimide resin composition of the present invention, since the varnish thereof exhibited no separation and turbidity, and since the cured product thereof not only excelled in dielectric properties but also exhibited a high adhesive force to metals and organic resins, there was confirmed the usefulness of the composition as an insulating material suitable for use in substrates.

What is claimed is:

1. A heat-curable maleimide resin composition comprising:
(A) a styrene-based elastomer having a reactive functional group at both ends;
(B) a maleimide compound represented by the following formula (1) 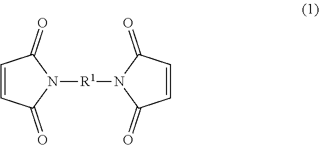
wherein R¹ represents a dimer acid skeleton-derived divalent hydrocarbon group;
(C) an epoxy resin having at least two epoxy groups per molecule; and
(D) an anionic polymerization initiating catalyst,
wherein a ratio between the components (A) and (B) (mass ratio (A)/(B)) is 2 to 20.

2. The heat-curable maleimide resin composition according to claim 1, wherein the styrene-based elastomer as the component (A) is a copolymer of styrene and a carbon-carbon double bond-containing compound, and the reactive functional group at the both ends thereof includes at least one of an amino group, a carboxyl group and a vinyl group.

3. The heat-curable maleimide resin composition according to claim 1, wherein the component (D) is at least one compound selected from an imidazole compound, a phosphorus compound and an amine compound.

4. An uncured resin film comprising the heat-curable maleimide resin composition according to claim 1.

5. A cured resin film comprising a cured product of the heat-curable maleimide resin composition according to claim 1.

6. An adhesive agent comprising the heat-curable maleimide resin composition according to claim 1.

7. An encapsulation material comprising the heat-curable maleimide resin composition according to claim 1.

8. A substrate comprising the cured product of the heat-curable maleimide resin composition according to claim 1.
